(19) United States
(12) Patent Application Publication
(10) Pub. No.: US 2006/0248287 A1
(43) Pub. Date: Nov. 2, 2006

(54) Methods and arrangements for reducing latency and snooping cost in non-uniform cache memory architectures

(75) Inventors: Alper Buyuktosunoglu, Putnam Valley, NY (US); Zhigang Hu, Ossining, NY (US); Jude A. Rivers, Cortlandt Manor, NY (US); John T. Robinson, Yorktown Heights, NY (US); Xiaowei Shen, Hopewell Junction, NY (US); Vijayalakshmi Srinivasan, New York, NY (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 11/118,130

(22) Filed: Apr. 29, 2005

(51) Int. Cl. G06F 13/28

(52) U.S. Cl. 711/146

(57) ABSTRACT

Arrangements and methods for providing cache management. Preferably, a buffer arrangement is provided that is adapted to record incoming data into a first cache memory from a second cache memory, convey a data location in the first cache memory upon a prompt for corresponding data, in the event of a hit in the first cache memory, and refer to the second cache memory in the event of a miss in the first cache memory.

This invention was made with Government support under Contact No. PERCS Phase 2, W0133970 awarded by DARPA. The Government has certain rights in this invention.

### FIELD OF THE INVENTION

The present invention generally relates to the management and access of cache memories in a multiple processor system. More specifically, the present invention relates to data lookup in multiple core non-uniform cache memory systems.

### BACKGROUND OF THE INVENTION

High-performance general-purpose architectures are moving towards designs that feature multiple processing cores on a single chip. Such designs have the potential to provide higher peak throughput, easier design scalability, and greater performance/power ratios. In particular, these emerging multiple core chips will be characterized by the fact that these cores will generally have to share some sort of a level two (L2) cache architecture but with non-uniform access latency. The L2 cache memory structures may either be private or shared among the cores on a chip. Even in the situation where they are shared, to achieve an optimized design, slices of the L2 cache will have to be distributed among the cores. Hence, each core, either in a shared or private L2 cache case, will have L2 cache partitions that are physically near and L2 cache partitions that are physically far, leading to non-uniform latency cache architectures. Therefore, these multi-core chips with non-uniform latency cache architectures can be referred to as multi-core NUCA chips.

Due to the growing trend towards putting multiple cores on the die, a need has been recognized in connection with providing techniques for optimizing the interconnection among the cores in a multi-core NUCA chip, the interconnection framework between multiple NUCA chips, and particularly how each core interacts with the rest of the multi-core NUCA architecture. For a given number of cores, the “best” interconnection architecture in a given multi-core environment depends on a myriad of factors, including performance objectives, power/area budget, bandwidth requirements, technology, and even the system software. However, a significant amount of performance, area and power issues are better addressed by the organization and access style of the L2 cache architecture. Systems built out of multi-core NUCA chips, without the necessary optimizations, may be plagued by:
high intra L2 cache bandwidth and access latency demands
high L2 to L3 cache bandwidth and access latency demands
high snooping demands and costs
non-deterministic L2, L3 access latency

Accordingly, a general need has been recognized in connection with addressing and overcoming shortcomings and disadvantages such as those outlined above.

### SUMMARY OF THE INVENTION

In accordance with at least one presently preferred embodiment of the present invention, there are broadly contemplated methods and arrangements for achieving reduced L2/L3 cache memory bandwidth requirements, less snooping requirements and costs, reduced L2/L3 cache memory access latency, savings in far L2 cache memory partition look-up access times, and a somewhat deterministic latency for L2 cache memory data in a multiple core non-uniform cache architecture based systems.

In a particular embodiment, given that the costs associated with bandwidth and access latency, as well as non-deterministic costs, in data lookup in a multi-core non-uniform level two (L2) cache memory (multi-core NUCA) system can be prohibitive, there is broadly contemplated herein the provision of reduced memory bandwidth requirements, less snooping requirements and costs, reduced level two (L2) and level three (L3) cache memory access latency, savings in far L2 cache memory look-up access times, and a somewhat deterministic latency to L2 cache memory data.

In accordance with at least one embodiment of the present invention, there is introduced an L2/L3 Communication Buffer (L2/L3 Comm Buffer) in a multi-core non-uniform cache memory system. The buffer (which is either distributed or centralized among L2 cache memory partitions) keeps record of incoming data into the L2 cache memory from the L3 cache memory or from beyond the multi-core NUCA L2 chip so that when a processor core needs data from the L2 cache memory, it is able to simply pin-point which L2 cache partition has such data and communicate in a more deterministic manner to acquire such data. Ideally, a parallel search amongst a near L2 cache memory directory and the L2/L3 Comm Buffer should provide an answer as to whether or not the corresponding data block is currently present in the L2 cache memory structure.

In summary, one aspect of the invention provides an apparatus for providing cache management, the apparatus comprising: a buffer arrangement; the buffer arrangement being adapted to: record incoming data into a first cache memory from a second cache memory; convey a data location in the first cache memory upon a prompt for corresponding data, in the event of a hit in the first cache memory; and refer to the second cache memory in the event of a miss in the first cache memory.

Another aspect of the invention provides a method for providing cache management, the method comprising the steps of: recording incoming data into a first cache memory from a second cache memory; conveying a data location in the first cache memory upon a prompt for corresponding data, in the event of a hit in the first cache memory; and referring to the second cache memory in the event of a miss in the first cache memory.

Furthermore, an additional aspect of the invention provides a program storage device readable by machine, tangibly embodying a program of instructions executable by the machine to perform method steps for for providing cache management, the method comprising the steps of: recording incoming data into a first cache memory from a second cache memory; conveying a data location in the first cache memory upon a prompt for corresponding data, in the event of a hit in the first cache memory; and referring to the second cache memory in the event of a miss in the first cache memory.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1a provides a schematic diagram of a single chip multiple core architecture with a shared L2 cache memory architecture.

FIG. 1b provides a schematic diagram of a single chip multiple core architecture with a private L2 cache memory architecture.

FIG. 2 provides a schematic diagram of a single chip multiple core architecture comprising of four processor cores and corresponding L2 cache memory structures.

FIG. 3 provides a schematic diagram of a single chip multiple core architecture comprising of four processor cores and corresponding L2 cache memory structures, where each of the L2 cache memories is retrofitted with a distributed L2/L3 Comm Buffer.

FIG. 4 provides a schematic diagram of a single chip multiple core architecture comprising of four processor cores and corresponding L2 cache memory structures, where the chip is retrofitted with a centralized L2/L3 Comm Buffer, equidistant from all the L2 cache structures.

FIG. 5 provides a flowchart of an L2 cache memory access in a multi-core NUCA chip in the presence of distributed L2/L3 Comm Buffers.

FIG. 6 provides a process of cache block allocation from the L3 cache memory into the L2 cache memory in presence of the distributed L2/L3 Comm Buffer.

FIG. 7 provides a flowchart of an L2 cache memory access in a multi-core NUCA chip in the presence of a centralized L2/L3 Comm Buffer.

FIG. 8 shows the process of cache block allocation from the L3 cache memory into the L2 cache memory in presence of a centralized L2/L3 Comm Buffer.

FIG. 9 provides a schematic diagram of a multi-core NUCA system that leverages the L2/L3 Comm Buffer in facilitating the remote sourcing of a cache block.

FIG. 10 provides a flow diagram of the parent node's request for a block invalidation or its acquisition in exclusive/modified mode, for the system described in FIG. 9.

FIG. 11 provides a flow diagram of the remote client node's request for a block invalidation or its acquisition in exclusive/modified mode, for the system described in FIG. 9.

### DESCRIPTION OF THE PREFERRED EMBODIMENTS

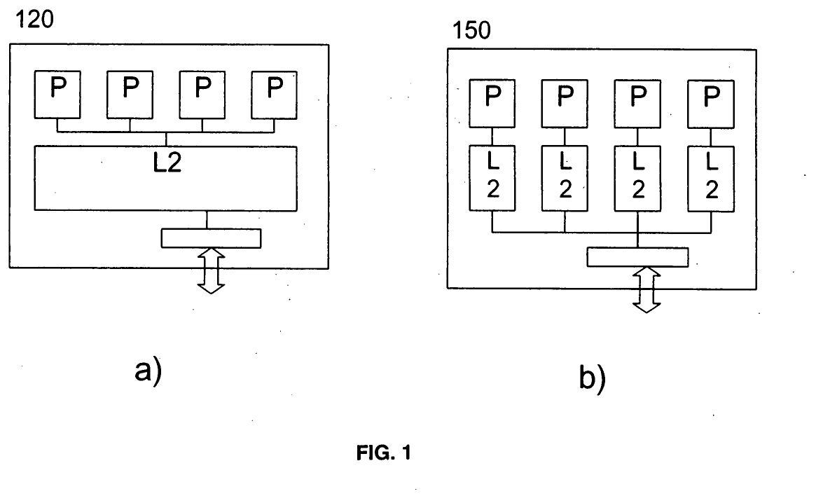

In accordance with at least one presently preferred embodiment of the present invention, there are addressed multi-core non-uniform cache memory architectures (multi-core NUCA), especially Clustered Multi-Processing (CMP) Systems, where a chip comprises multiple processor cores associated with multiple Level Two (L2) caches as shown in FIG. 1. The system built out of such multi-core NUCA chips may also include an off-chip Level Three (L3) cache (and/or memory). Also, it can be assumed that L2 caches have one common global space but are divided in proximity among the different cores in the cluster. In such a system, access to a cache block resident in L2 may be accomplished in a non-uniform access time. Generally, L2 objects will either be near to or far from a given processor core. A search for data in the chip-wide L2 cache therefore may involve a non-deterministic number of hops from core/L2 pairs to reach such data. Hence, L2 and beyond access and communication in the multi-core NUCA systems can be potentially plagued by higher L2/L3 bandwidth demands, higher L2/L3 access latency, higher snooping costs, and non-deterministic access latency.

The L2 cache memory architecture for the single multi-core chip architecture can be either shared (120) as shown in FIG. 1(a) or private (150) as in FIG. 1(b), or a combination of the two. A shared L2 cache architecture, in this case, describes a setup where multiple processor cores share one uniform L2 cache with a single directory/tag storage, put on a common bus. In that case, the access latency from any processor core to any part of the L2 cache memory is fixed for all processor cores.

Shared caches are efficient in sharing the cache capacity but require high bandwidth and associativity. This is due to one cache serving multiple processors and for avoiding potential conflict misses. Since access from each processor core to any part of the cache is fixed, a shared cache has high access latency even when the data sought after is present in the cache. A private L2 cache architecture is where the L2 cache is uniquely divided among the processor cores, each with it own address space and directory/tag storage and operates independent of the other. A processor first presents a request to its private L2 cache memory, a directory look-up occurs for that private L2 cache memory, and the request is only forwarded to the other L2 cache structures in the configuration following a miss. Private caches are well coupled with the processor core (and often with no buses to arbitrate for) and consequently do provide fast access. Due to their restrictive nature, private caches tend to present bad caching efficiency and long latency for communication. In particular, if a given processor core is not efficiently using its L2 private cache but other processor cores need more L2 caching space, there is no way to take advantage of the less used caching space.

An alternative attractive L2 cache memory organization for the multi-core chip is a NUCA system of cache where the single address space L2 cache and its tag are distributed among the processor cores just as shown in the private cache approach in FIG. 1b). Each of the cache partition in that case would potentially have a full view of the address space and consequently all the cache partitions may act as the mirror images of each other. Hence, there is the concept of near and far cache segments, relative to a processor core. Likewise, there are multiple latencies from a processor core to various L2 cache segments on chip. Basically, a given block address should map to a corresponding location across all the cache partitions.

Although an exemplary multi-core non uniform cache memory (multi-core NUCA) system is used in discussions of the present invention, it is understood that the present invention can be applied to other chip multiple processor (CMP) and symmetric multiple processor (SMP) systems that include multiple processors on a chip, and/or multiprocessor systems in general.

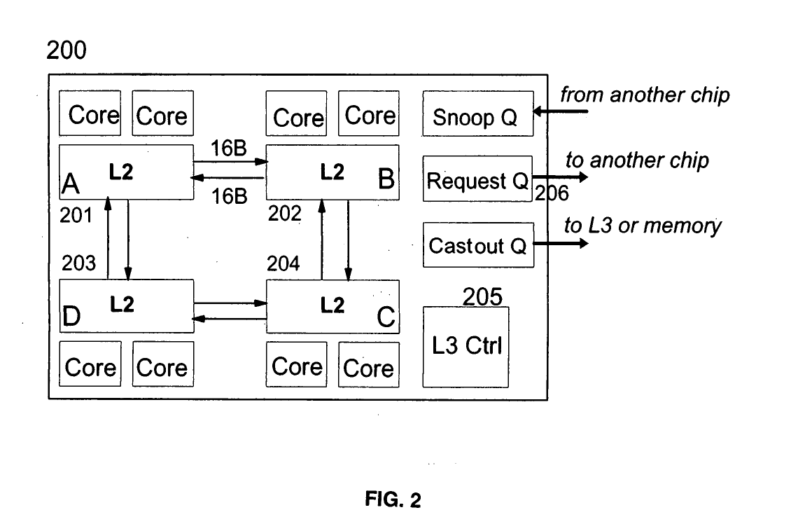

The bandwidth, access latency, and non-deterministic cost of data lookup in a multi-core NUCA system can be illustrated by the steps involved in an L2 cache memory access as illustrated in FIG. 2, using a conventional methodology 200. One such L2 cache memory access lookup would involve the following steps. Suppose a near L2 cache memory lookup occurs in core/L2 cache memory pair A 201, and the data is not found. Such a near L2 cache memory miss in A 201 will result in a snoop request sent out sequentially clockwise to core/L2 cache memory pairs B 202, C 203, D 204. Suppose there would be a far L2 cache memory hit in C 203, lookups could still occur sequentially in B 202 and C 203. In this case, the target data will be delivered to A 201 from C 203 in two hops. If there were no far L2 cache hit, the request would subsequently be forwarded to the L3 controller 205 (after the sequential lookup in A 201, B 202, C 203, and D 204), which would perform the L3 directory lookup. In addition, the outgoing Request Queue 206 would capture the address and then onto memory if L2 and L3 miss. Clearly, this approach requires more L2 bandwidth, puts out more snooping requests, and makes L2 cache memory data access non-deterministic both in latency and hops.

Alternatively, suppose again that a near L2 cache memory lookup occurs in A 201, and the data is not found. The near L2 cache memory miss in A 201 will result in a snoop request put on the bus for parallel lookup amongst B 202, C 203, and D 204. Even though a far L2 cache memory hit would occur in C 203, all the other caches must do a lookup for the data. Granted that this approach alleviates the latency and some of the non-deterministic issues associated with the prior approach discussed, there are still more bandwidth and snoopy requests put out on the bus in this approach. In particular, the parallel lookup that must occur will be bounded by the slowest lookup time amongst core/L2 cache memory pairs B 202, C 203, and D 204; and that can potentially affect the overall latency to data. This approach still requires more L2 bandwidth and more snooping requests.

In accordance with at least one presently preferred embodiment of the present invention, an objective is to provide reduced L2/L3 cache memory bandwidth requirements, less snooping requirements and costs, reduced L2/L3 cache memory access latency, savings in far L2 cache memory partition look-up access times, and a somewhat deterministic latency to L2 cache memory data.

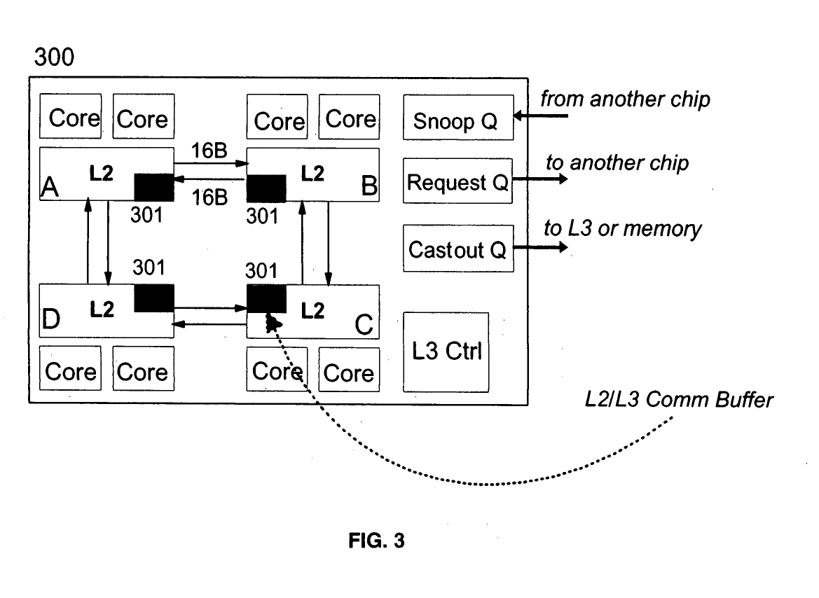

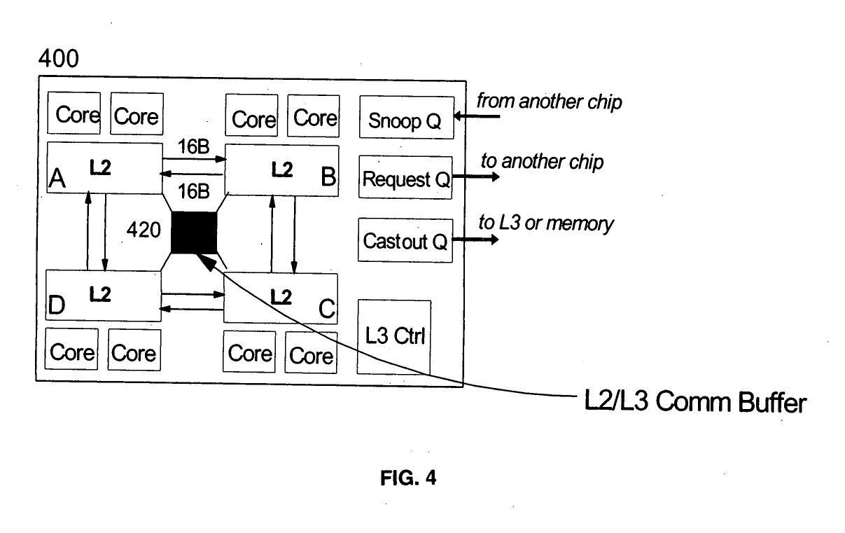

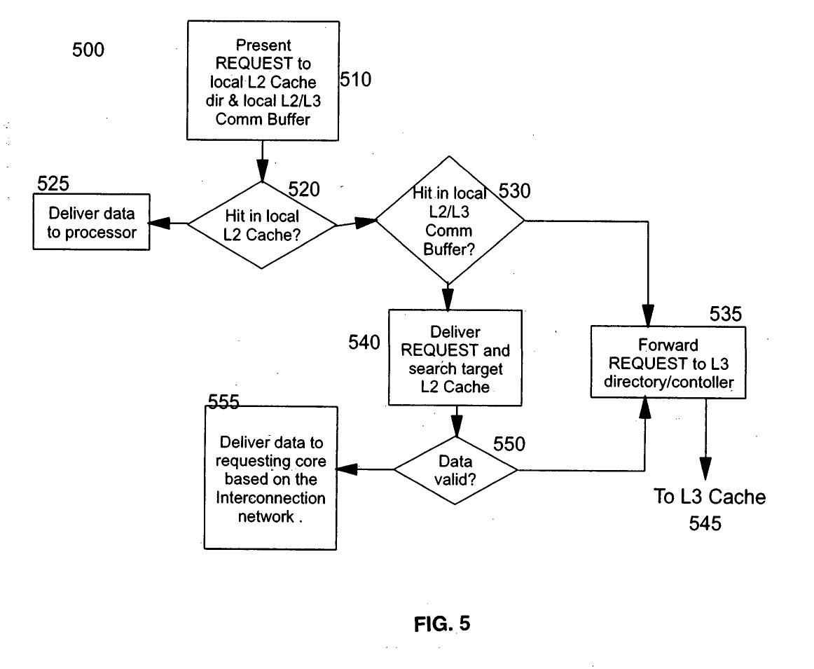

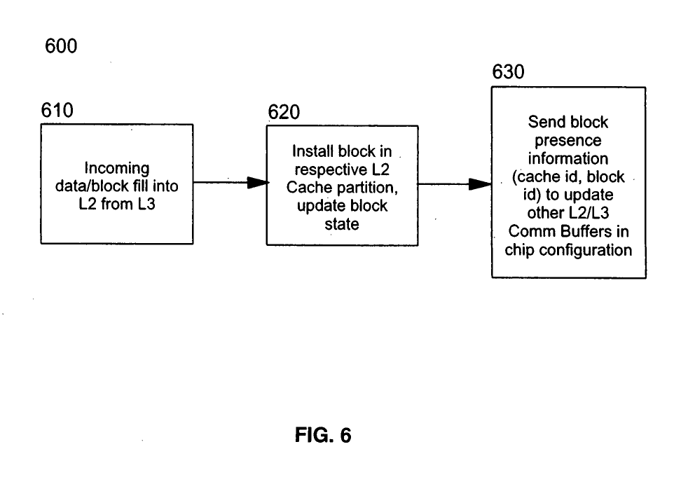

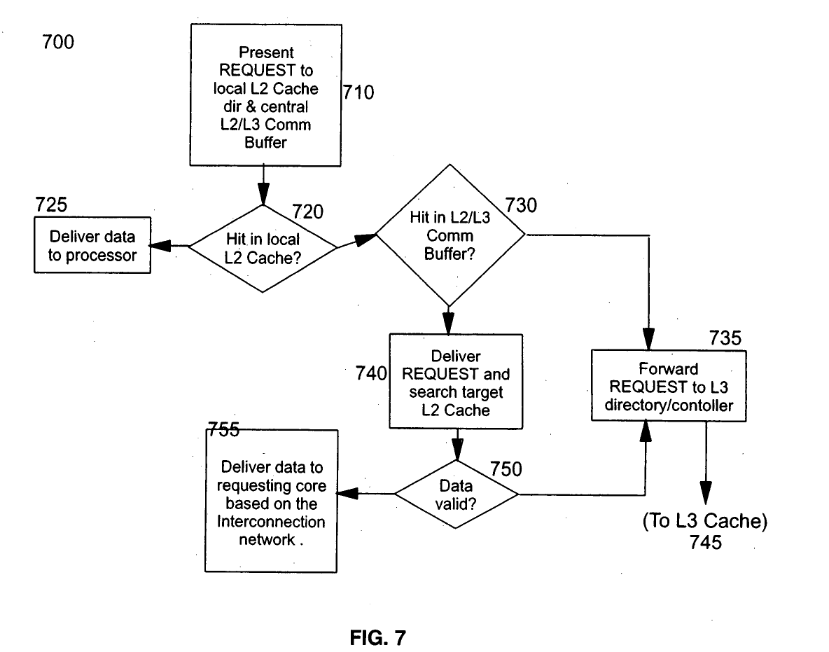

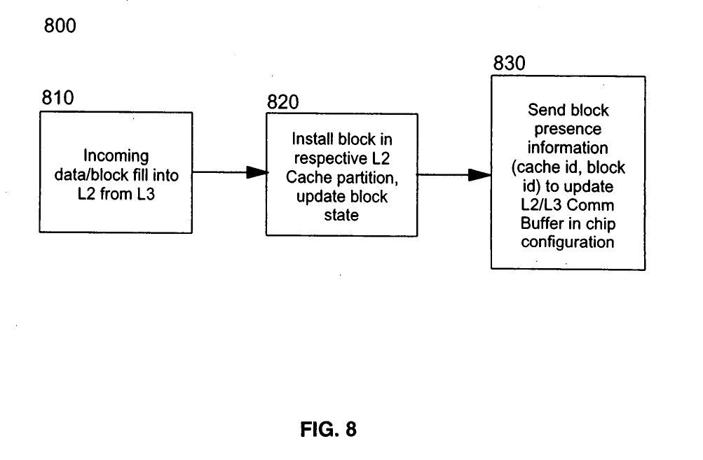

In accordance with a preferred embodiment of the present invention, there is preferably provided what may be termed an L2/L3 Communication Buffer, hereafter referred to simply as “L2/L3 Comm Buffer”. The L2/L3 Comm Buffer is an innovative approximation of a centralized L2-L3 directory on chip. Basically, the L2/L3 Comm Buffer keeps record of incoming data into the L2 cache memory from the L3 cache memory so that when a processor core needs data from the L2, it is able to simply pin-point which L2 partition has such data and communicate in a more deterministic manner to acquire such data. In an ideal and exact scenario therefore, when an aggregate search amongst a near L2 cache directory and the L2/L3 Comm Buffer results in a miss, then the request must be passed on to the L3 cache directory and controller for access. The buffer can either be distributed 300 (as shown in FIG. 3) or centralized 400 (as shown in FIG. 4).

In the case of the distributed approach 300, every L2 directory is assigned a portion of the buffer 301. When a block is first allocated or brought into a given L2 cache on the chip, the receiving L2 (which is practically the owner or the assignee of the incoming data) will communicate to the other L2/L3 Comm Buffers 301 that it does possess the given data object or block. This communication may be achieved through a ring-based or point-to-point broadcast. The other L2/L3 Comm Buffers 301 will store the data block address and the L2/core ID of the resident cache that has the data. If a copy of block later moves from one L2 cache onto other L2s in a shared mode in the same chip, there will be no need to update the stored states in the other L2/L3 Comm Buffers 301. However, if a block were to be acquired in an Exclusive or Modified mode by another L2, there is the need to update the states in the other L2/L3 Comm Buffers.

In the case of the centralized approach 400, one centralized buffer 420 may be placed equidistant from all the L2 directories in the structure. Such structure 420 will need to be multi-ported and highly synchronized to ensure that race problems do not adversely affect its performance. When an object or block is first allocated into the L2 from L3, an entry is entered in the L2/L3 Comm Buffer 420 showing which L2 has the data. Again, an L2/L3 Comm Buffer 420 entry will consist of the data block address and the resident L2/core ID. Just like the distributed approach, when another L2 subsequently claims the data in Exclusive or Modified mode, the entry in the L2/L3 Comm Buffer 420 will need to be updated to reflect this.

The acceptable size and number of entries in the L2/L3 Comm Buffer 301 420 depends greatly on availability of resources, how much performance improvement is sought, and in the case of not keeping all entries, how best to capture and exploit the running workload's inherent locality.

To achieve the real advantages of adopting the L2/L3 Comm Buffer, the interconnection network that connects multiple processors and caches in a single chip system may need to adapt to the L2/L3 Comm Buffer's usage and operation. The basic usage and operation of the L2/L3 Comm Buffer in a multi-core NUCA system, in accordance with at least one preferred embodiment of the present invention, is illustrated as follows. An L2/L3 Comm Buffer is either distributed or centralized; contemplated here is an interconnection network among the L2 cache system that is either ring-based or point-to-point. In addition, the remote data lookup could either be serial or parallel among the remote caches. (Note: the terms “remote” or “far”, as employed here, simply refer to other L2 caches on the same multi-core NUCA chip).

The servicing of an L2 cache request in a multi-core NUCA system with a distributed L2/L3 Comm Buffer 500 may preferably proceed as follows:
1. An L2 cache request is presented to both the local L2 cache directory and the local L2/L3 Comm Buffer 510. A parallel lookup occurs in both structures simultaneously.
2. A miss in the local L2 cache 520 but a hit in the L2/L3 Comm Buffer 530 signifies a remote/far L2 cache hit.
2a. For a hit in a far L2, the system interconnection network determines request delivery (e.g. point-to-point or ring-based).
2b. Based on the system interconnection network, the request will be routed directly to the target L2 cache memory partition 540. This could be a single hop or multiple hops. (May lead to reduced snooping, address broadcasting, and unnecessary serial or parallel address lookups).
3. Target L2 cache memory partition will return data, based on the system interconnection network 555.
   3a. For a point-to-point network, data may be sent in a single hop as soon as the bus is arbitrated for.
   3b. For a ring-based network, data may be sent in multiple hops based on the distance from the requesting node.
4. A miss in both the local L2 520 and the L2/L3 Comm Buffer 530 may signify a total L2 miss, the request is forwarded to the L3 controller 535, which also performs the L3 directory lookup in parallel
5. The outgoing Request Queue captures the address and if shown that data is not present in L3 cache memory 545 then:
   5a. For single-chip multi-core NUCA system, get data from memory
   5b. For multiple chip multi-core NUCA system, send the address to the multi-chip interconnect network.

As discussed here below, the actual usage and operation of a centralized L2/L3 Comm Buffer is not different from the distributed usage as outlined above. Basically, the approach as discussed here below reduces on-chip memory area needed to keep cumulative information for the L2/L3 Comm Buffer. However, it requires at least n memory ports (for an n node system) and multiple lookups per cycle.

Accordingly, the servicing an L2 cache request in a multi-core NUCA system with a centralized L2/L3 Comm Buffer 700 may preferably proceed as follows:
1. An L2 cache request is presented to both the local L2 cache directory and the centralized L2/L3 Comm Buffer 710. A parallel lookup occurs in both structures simultaneously.
2. A hit in the local L2 cache partition 720 and a hit in the L2/L3 Comm Buffer 730. Always the local L2 cache hit overrides, abandon the L2/L3 Comm Buffer hit, and deliver the data to the requesting processor 725.
3. A miss in the local L2 cache memory 720 but a hit in the L2/L3 Comm Buffer 730 signifies a remote/far L2 cache hit 740.
   3a. For a hit in a far L2, the system interconnection network determines request delivery (e.g. point-to-point or ring-based).
   3b. Based on the system interconnection network, the request will be routed directly to the target L2 cache memory partition 740. (May lead to reduced snooping, address broadcasting, and unnecessary serial or parallel address lookups).
4. Target L2 will return data, based on the system interconnection network 755.
   4a. For a point-to-point network, data may be sent in a single hop as soon as the bus is arbitrated for.
   4b. For a ring-based network, data may be sent in multiple hops based on the distance from the requesting node.
5. A miss in the L2/L3 Comm Buffer may signify a total L2 miss, the request is forwarded to the L3 controller 735, which also performs the L3 directory lookup in parallel
6. The outgoing Request Queue captures the address and if shown that data is not present in L3 cache memory 745 then:
   6a. For single-chip multi-core NUCA system, get data from memory
   6b. For multiple chip multi-core NUCA system, send the address to the multi-chip interconnect network.

As mentioned above, the interconnection network adapted in an on-chip multi-core NUCA system can have varying impact on the performance of the L2/L3 Comm Buffer. Discussed below are the expected consequences of either a ring-based network architecture or a point-to-point network architecture. Those skilled in the art will be able to deduce the effects of various other network architectures.

For a ring-based architecture, there are clearly many benefits to servicing an L2 cache memory request, which include the following, at the very least:
The L2/L3 Comm Buffer makes the data look-up problem a deterministic one.
Reduction in the number of actual L2 cache memory lookups that must occur.
potential point-to-point address request delivery.
potential data delivery in multiple hops
Deterministic knowledge as to where data is located provides a latency-aware approach to data access and potential power savings on-chip and speedup access to L3 cache memory and beyond

On the other hand, if the architecture facilitates a one-hop point-to-point communication between all the L2 cache nodes, the approaches contemplated herein will accordingly achieve an ideal operation.

Servicing an L2 cache memory request may therefore benefit greatly, for at least the following reasons:
The L2/L3 Comm Buffer makes the data look-up problem a deterministic one
Reduction in the number of actual L2 cache lookups that must occur
   potential point-to-point address request delivery
   potential point-to-point or (multi-hop) data delivery
Deterministic knowledge as to where data is located can result in a reduction in on-chip snooping, latency-aware data lookup, and speedup access to L3 and beyond.

Preferably, the size and capacity of the L2/L3 Comm Buffer will depend on the performance desired and the chip area that can be allocated for the structure. The structure can be exact, i.e. the cumulative entries of the distributed L2/L3 Comm Buffers the entries in the centralized L2/L3 Comm Buffer capture all the blocks resident in the NUCA chip L2 cache memory. On the other hand, the L2/L3 Comm Buffer can be predictive where a smaller size L2/L3 Comm Buffer is used to try to capture only information about actively used cache blocks in the L2 cache system. In the case where the predictive approach is used, the L2/L3 Comm Buffer usage/operation procedures as shown in the previous section will have to change to reflect that. In the case of the distributed L2/L3 Comm Buffer, step 4 may be altered as follows:
4. A miss in both the local L2 and the L2/L3 Comm Buffer will require a parallel forwarding of requests to far L2 cache structures and to the L3 controller, which also performs the L3 directory lookup in parallel.
   4a. If a far L2 responds with a hit, then cancel the L3 cache access

Similarly, in the case of the centralized L2/L3 Comm Buffer, step 5 may be changed as follows:
5. A miss in the L2/L3 Comm Buffer requires a parallel forwarding of requests to far L2s and to the L3 controller, which also performs the L3 directory lookup in parallel.
5a. If a far L2 responds with a hit, then cancel the L3 access

Clearly, being able to facilitate an exact L2/L3 Comm Buffer is a far more superior performance booster, perhaps power savings booster as well, than the predictive version

In a preferred embodiment, the L2/L3 Comm Buffer may be structured as follows:
organized as an associative search structure; set associate or fully associative structure, indexed with a cache block address or tag
an L2/L3 Comm Buffer entry for a cache block entry is identified by the tuple entry (block address or tag, home node (core/L2 cache) ID), referred to as the block presence information.

A cache block's entry only changes as follows:
invalidated, when the block is evicted completely from the NUCA chip's L2 cache system
modified, when a different node obtains the block in an

Exclusive/Modified Mode

In an exact L2/L3 Comm Buffer approach,
no replacement policy is needed since the L2/L3 Comm Buffer should be capable of holding all possible L2 blocks in the L2 cache system.

In a predictive L2/L3 Comm Buffer approach, replacement policy is LRU
other filtering techniques may be employed to help with block stickiness, so that cache blocks with high usage and locality will tend to be around in the buffers.

The allocation of entries and management of the L2/L3 Comm Buffer, in accordance with at least one embodiment of the present invention, is described here below.

For the distributed L2/L3 Comm Buffer 600, when a cache block is first allocated or brought into the given L2 cache on the chip 610, the receiving L2 cache structure (which is considered the owner or parent of the block) will install the block in the respective set of the structure and update the cache state as required 620. The receiving L2 cache assembles the block presence information (block address or tag, home node (core/L2 cache) ID). The receiving L2 cache then sends 630 the block presence information to the other L2/L3 Comm Buffers 301, announcing that the node does possess the given data object. Sending the block presence information may be achieved through a ring-based or point-to-point broadcast. The receiving L2/L3 Comm Buffers 301 will store the block presence information. If a copy of the data object were later to move from the parent L2 cache onto other L2 caches in a shared mode in the same chip, there will be no need to update the stored states in the other L2/L3 Comm Buffers 301.

For the centralized L2/L3 Comm Buffer 800, when a cache block is first allocated or brought into the given L2 cache on the chip 810, the receiving L2 cache structure (which is considered the owner or parent of the block) will install the block in the respective set of the structure and update the cache state as required 820. The receiving L2 cache assembles the block presence information (block address or tag, home node (core/L2 cache) ID). The receiving L2 cache then sends 830 the block presence information to the central L2/L3 Comm Buffer 420, announcing that the node does possess the given data object. Just like the distributed approach, when another L2 subsequently claims the data in Exclusive or Modified mode, the entry in the L2/L3 Comm Buffer 420 will need to be updated to reflect this.

In a multiprocessor system with multiple L2 cache memory structures, such as the one described here, a cache line/block held in a Shared state may have multiple copies in the L2 cache system. When this block is subsequently requested in the Exclusive or Modified mode by one of the nodes or processors, the system then grants exclusive or modified state access to the requesting processor or node by invalidating the copies in the other L2 caches. The duplication of cache blocks at the L2 cache level does potentially affect individual cache structure capacities, leading to larger system wide bandwidth and latency problems. With the use of the L2/L3 Comm Buffer, a node requesting a cache block/line in a shared mode may decide to remotely source the cache block directly into its level one (L1) cache without a copy of the cache block being allocated in its L2 cache structure.

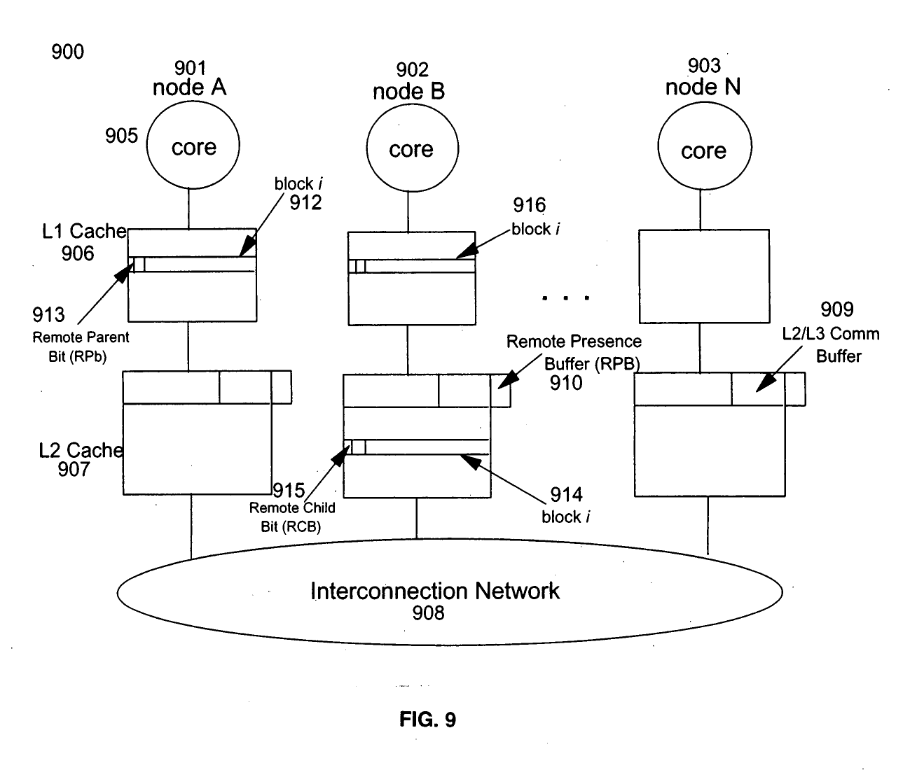

FIG. 9 presents a preferred embodiment 900 for remote cache block sourcing in a multi-core NUCA system in the presence of distributed L2/L3 Comm Buffers 909. FIG. 9 describes multiple nodes 901, 902, 903 forming a multi-core NUCA system. Each node comprises of a processor core 905, a level one (L1) cache 906, a level two (L2) cache 907, all linked together by an appropriate interconnection network 908. Each cache block entry in the L1 cache has a new bit, Remote Parent Bit (RPb) 913 associated with it. Also, each cache block entry in the L2 cache has a new bit, Remote Child Bit (RCB) 915 associated with it. In addition, each L2 cache structure has an L2/L3 Comm Buffer 909 and a Remote Presence Buffer RPB) 910 associated with it. The Remote Presence Buffer 910 is simply a collection of L2 cache block addresses or tags, for cache blocks that have been remotely sourced from other nodes in the corresponding L1 cache of the L2 cache holding the RPB.

For the operation and management of remote sourcing, suppose block i is originally allocated in node B 902, in the L1 cache 916 and L2 cache 914 as shown. Suppose the processor core 905 of node A 901 decides to acquire block i in a shared mode. Unlike the traditional approach, node B's L2 cache will forward a copy of block i directly to node A's processor core 905 and L1 cache 906, without a copy being allocated and saved at node A's L2 cache 907. In addition, node B's L2 cache will set the Remote Child Bit (RCB) 915 of its copy of block i to 1, signifying that a child is remotely resident in an L1 cache. When the new block i 912 is allocated in node A's L1 cache 906, the block's associated Remote Parent Bit 913 will be set to 1, signifying that it is a cache block with no direct parent in the node A's L2 cache. In addition, in the Remote Presence Buffer 910 of Node A, block i's address/tag will be entered as an entry in the buffer. Node A's processor 905 can then go ahead and use data in block i as needed. It should be realized that other nodes in the multi-core NUCA system can also request and acquire copies of block i into their L1 caches following the procedure as described.

From the foregoing description of the transaction involving block i between node B and node A, it can be considered that node A is the client. Node B remains the parent of block i and can be described as the server in the transaction. Now, suppose either the server or the client needs to either invalidate block i or acquire block i in exclusive or modified state.

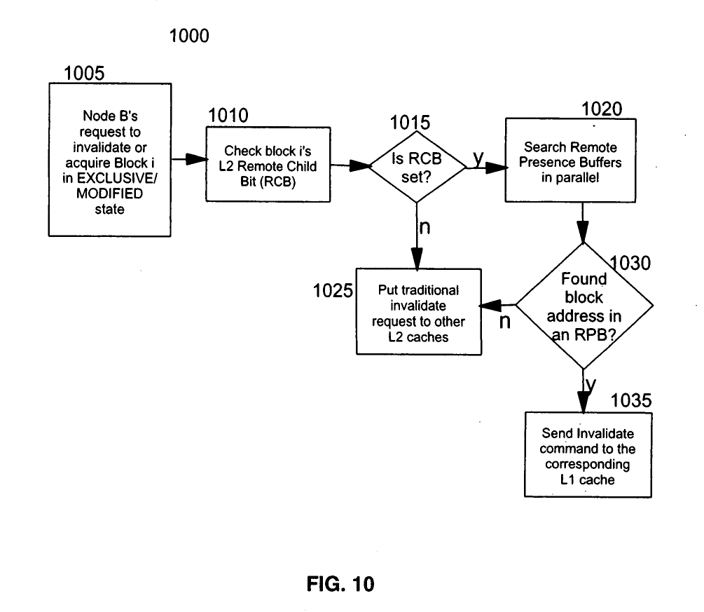

The flow of events 1000 in FIG. 10 describes how to achieve block i's state coherent, should node B request to invalidate or acquire block i in an exclusive/modified mode 1005. Node B's L2 cache will first check the block's Remote Child Bit 1010. If the RCB is set 1015, suggesting that there are child copies in remote L1 caches, a search of the block's address will be put out to the other nodes' Remote Presence Buffers 1020. When the matching block address is found in an RPB 1030, a direct invalidate command is sent to the respective node's L1 cache to forcibly invalidate its copy 1035. In the event that the RCB bit check and/or the RPB lookup turns out negative, the system resorts to the traditional approach where an invalidate request is put out to every L2 cache 1025.

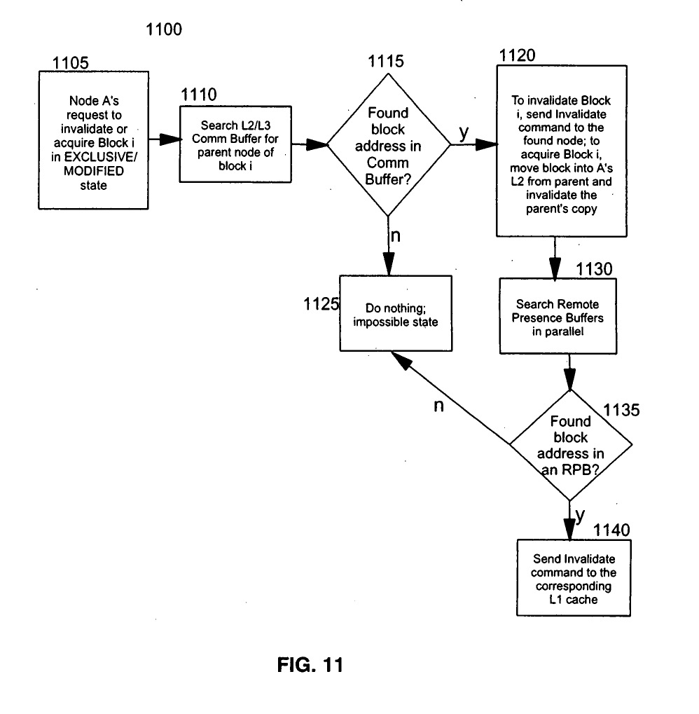

The flow of events 1100 in FIG. 11 describes how to render block i's state coherent, should node A decide to either invalidate or acquire block i in an exclusive/modified mode 1105. Noting from the Remote Parent bit (RPb) check, Node A will use Block i's address to search in its L2/L3 Comm Buffer for the block's parent location 1110. Remember that this system should not allow for duplication of blocks to be resident in the L2 cache system. If the block's parent location is found from the L2/L3 Comm Buffer 1115, an invalidate command is sent to the node for invalidation 1120. To acquire the block in an exclusive/modified mode, a copy of the block is first moved to the requested node's L2 cache, the L2/L3 Comm Buffers updated accordingly 1120, while the original parent is invalidated. In addition, an invalidate request for the block is put on the network where a search occurs in all the RPBs 1130 and wherever found 1135, a forced invalidate of the block occurs in the L1 cache 1140.

It is to be understood that the present invention, in accordance with at least one presently preferred embodiment, includes a buffer arrangement adapted to record incoming data, convey a data location, and refer to a cache memory, which may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirely herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An apparatus for providing cache management, said apparatus comprising:
a buffer arrangement;
said buffer arrangement being adapted to:
record incoming data into a first cache memory from a second cache memory;
convey a data location in the first cache memory upon a prompt for corresponding data, in the event of a hit in the first cache memory; and
refer to the second cache memory in the event of a miss in the first cache memory.

2. The apparatus according to claim 1, wherein the first cache memory is an L2 cache memory and the second cache memory is an L3 cache memory.

3. The apparatus according to claim 1, wherein said buffer arrangement comprises a distributed buffer arrangement and a centralized buffer arrangement.

4. The apparatus according to claim 2, wherein the conveyed data location is a partition in the L2 cache memory.

5. The apparatus according to claim 2, wherein the L2 cache memory is a non-uniform L2 cache memory.

6. The apparatus according to claim 2, wherein the L2 cache memory and L3 cache memory are disposed in a multi-core cache memory architecture.

7. The apparatus according to claim 2, wherein the L3 cache memory comprises an off-chip cache memory.

8. The apparatus according to claim 2, wherein the L2 cache memory comprises a shared L2 cache memory.

9. The apparatus according to claim 2, wherein the L2 cache memory comprises a private L2 cache memory.

10. The apparatus according to claim 2, wherein said buffer arrangement is further adapted to remotely source data in an L1 cache memory when corresponding data is not allocated into the L2 cache memory.

11. A method for providing cache management, said method comprising the steps of:
recording incoming data into a first cache memory from a second cache memory;
conveying a data location in the first cache memory upon a prompt for corresponding data, in the event of a hit in the first cache memory; and
referring to the second cache memory in the event of a miss in the first cache memory.

12. The method according to claim 11, wherein the first cache memory is an L2 cache memory and the second cache memory is an L3 cache memory.

13. The method according to claim 12, wherein the conveyed data location is a partition in the L2 cache memory.

14. The method according to claim 12, wherein the L2 cache memory is a non-uniform L2 cache memory.

15. The method according to claim 12, wherein the L2 cache memory and L3 cache memory are disposed in a multi-core cache memory architecture.

16. The method according to claim 12, wherein the L3 cache memory comprises an off-chip cache memory.

17. The method according to claim 12, wherein the L2 cache memory comprises a shared L2 cache memory.

18. The method according to claim 12, wherein the L2 cache memory comprises a private L2 cache memory.

19. The method according to claim 12, further comprising the step of remotely sourcing data in an L1 cache memory when corresponding data is not allocated into the L2 cache memory.

20. A program storage device readable by machine, tangibly embodying a program of instructions executable by the machine to perform method steps for for providing cache management, said method comprising the steps of:
recording incoming data into a first cache memory from a second cache memory;
conveying a data location in the first cache memory upon a prompt for corresponding data, in the event of a hit in the first cache memory; and
referring to the second cache memory in the event of a miss in the first cache memory.
